(19) United States
(12) Patent Application Publication
(10) Pub. No.: US 2014/0202619 A1
(43) Pub. Date: Jul. 24, 2014

(54) ADHESIVE BONDING FOR A PNEUMATIC TIRE

(71) Applicant: The Goodvear Tire & Rubber Company, Akron, OH (US)

(72) Inventor: Paul Harry Sandstrom, Cuyahoga Falls, OH (US)

(73) Assignee: The Goodvear Tire & Rubber Company, Akron, OH (US)

(21) Appl. No.: 13/744,671

(22) Filed: Jan. 18, 2013

(51) Int. Cl. B29D 30/08

(52) U.S. Cl. CPC B29D 30/08
USPC 156/96; 156/394.1; 156/379.6; 156/128.1

(57) ABSTRACT

A system for constructing a pneumatic tire includes a tread component having two opposite tread splice ends, a water based adhesive applied to the tread splice ends for securing the tread splice ends to each other; and a heating means applied to the tread splice ends and water based adhesive for reducing drying duration of the water based adhesive.

### FIELD OF THE INVENTION

The present invention relates to an improved tire tread splicing system and method and, more particularly, to a system and method of applying water based cement to the bias-cut ends of a tire tread. The present invention further relates to new and useful methods for producing pneumatic tires utilizing such improved system and/or method.

### BACKGROUND OF THE INVENTION

Rubber tires are often prepared in a manufacturing process by first building a tire carcass and then building a tire tread thereon. The tire tread is conventionally applied to the tire carcass as a relatively flat, wide, sometimes somewhat contoured, uncured rubber strip which is wound around the carcass with the ends of the uncured rubber strip meeting to form a splice. Tread for retreading is often cut at a 90° angle. The ends of the conventional rubber tread strip for a new tire are usually skived, or cut at an angle other than 90° so that the spliced ends overlap each other.

Generally, it is desired that the uncured rubber tread strip has a degree of tackiness, sometimes referred to as building tack, so that the tread splice holds together after its construction and is suitable for a subsequent tire cure step. However, the uncured tread strip often does not have sufficient natural building tack for such purpose.

Therefore, an adhesive is often applied to the faces of the opposing surfaces of the tire tread strip splice so that sufficient building tack is present and so that the tread splice may become more securely bonded. For this operation, it is common to apply a solvent based adhesive rubber composition, or cement, to one, and sometimes both, faces of the opposing tire tread splice ends.

Examples of solvent based adhesives for such purpose and rubber tread splices joined by such adhesives, in general, are disclosed in one or more of U.S. Pat. Nos. 3,335,041; 3,342,238; 3,421,565; 3,514,423; 4,463,120; and 4,539,365. Such exemplary cements are typically based on, for example, solvent solutions of compositions comprised, for example, of a base rubber, a hydrocarbon oil, carbon black, a tackifier resin, and a curative.

The tread splice cement/adhesive requires enough cohesive and adhesive strength to hold the tread splice joint together using only the green tack of the cement/adhesive until and during curing. The circumference of the tire in the tread region may increase slightly in a tire curing press thereby further straining the tread splice joint.

Due to the small adhesion area and large strain potentially applied to a tread splice joint, adhesives for this application are conventionally solvent based cements. The solvents increase the molecular mobility of the polymers in the adhesive and increase the wetting of the rubber substrate (e.g., tread splice ends). Good wetting and molecular mobility promote good adhesion to the substrate (e.g., the tread). Water based adhesives have replaced rubber cements in some less demanding applications, due to their lower volatile organic emissions. However, the superior performance of solvent based cements has continued to dictate their use for tread splice joints. For many years, natural rubber adhesives were considered superior to most known synthetic adhesives, even for manufacture of SBR-type (butadiene-styrene) rubber tires. Synthetic rubber tire adhesives have been discovered which produce tires at least equal to those having the rubber portions adhered with natural rubber adhesives.

### SUMMARY OF THE PRESENT INVENTION

A system for constructing a pneumatic tire, in accordance with the present invention, includes a tread component having two opposite tread splice ends, a water based adhesive applied to the tread splice ends for securing the tread splice ends to each other; and a heating means applied to the tread splice ends and water based adhesive for reducing drying duration of the water based adhesive.

According to another aspect of the system, the heating means is applied to the tread splice ends prior to application of the water based adhesive.

According to still another aspect of the system, the tread component is cured.

According to yet another aspect of the system, the tread component is uncured.

According to still another aspect of the system, the water based adhesive also secures the tread component to a tire carcass structure.

According to yet another aspect of the system, the heating means comprises one or more of the group consisting of infrared heaters, convection heaters, radiant heaters, and induction heaters.

According to still another aspect of the system, the pneumatic tire is a retreaded pneumatic tire.

According to yet another aspect of the system, the water based adhesive includes elastomers from the group consisting of natural rubber, styrene butadiene rubber, polybutadiene rubber, and mixtures thereof.

According to still another aspect of the system, the water based adhesive comprises 35 percent to 50 percent total weight of elastomer.

According to yet another aspect of the system, the water based adhesive includes about 0.02 to 0.6 weight percent pH adjusters selected from the group of potassium hydroxide, aqueous ammonia, and mixtures thereof.

A method for constructing a pneumatic tire, in accordance with the present invention, includes the steps of: providing a tread component having two opposite tread splice ends; securing the tread splice ends to each other with a water based adhesive applied to the tread splice ends; and applying heat to the tread splice ends and water based adhesive for reducing drying duration of the water based adhesive.

According to another aspect of the method, the applying step is applied to the tread splice ends prior to the securing step.

According to still another aspect of the method, the tread component is cured.

According to yet another aspect of the method, the tread component is uncured.

According to still another aspect of the method, the securing step further includes securing the tread component to a tire carcass structure with the water based adhesive.

According to yet another aspect of the method, the applying step includes utilizing a heating means of the group consisting of infrared heaters, convection heaters, radiant heaters, and induction heaters.

According to still another aspect of the method, the pneumatic tire is a retreaded pneumatic tire.

According to yet another aspect of the method, the water based adhesive includes elastomers from the group consisting of natural rubber, styrene butadiene rubber, polybutadiene rubber, and mixtures thereof.

According to still another aspect of the method, the water based adhesive comprises 35 percent to 50 percent total weight of elastomer.

According to yet another aspect of the method, the water based adhesive includes about 0.02 to 0.6 weight percent pH adjusters selected from the group of potassium hydroxide, aqueous ammonia, and mixtures thereof.

A water based cement for use with the present invention may be exclusive of alkoxysilane and alkylsilane containing compounds and may be comprised of, based on parts by weight per 100 parts by weight rubber (phr):

(A) at least one diene-based elastomer latex (e.g. aqueous elastomer emulsion);

(B) silica coupling agent compound comprised of at least one of:
(1) carboxymaleimidophenhyl ester;
(2) disodium salt of 2,2′-dithiosalicylic acid;
(3) bis-succimide polysulfide;
(4) 2-benzothiozyl-3-(propane-1,2-diol);
(5) o-salicylalicylic acid;
(6) pyrazine amide;
(7) 3,3′-tetrathiodipopanol;
(8) hydroxyethyl-phenoxyacetic acid;
(9) 3,3′-tetrathiodiproopionamide;
(10) poly-(2-propanol-1,3-polysulfide);
(11) 3,3′-tetrathiodipropionitrile;
(12) nicotinamide;
(13) zinc and sodium salts of salicylic acid;
(14) diamompdorpsomate salt; and
(15) bisaniline PD bismaleimide; and

(C) optionally sulfur and at least one sulfur cure accelerator.

According to another aspect of the water based adhesive, the diene-based elastomer latex is natural rubber latex.

According to still another aspect of the water based adhesive, the adhesive may contain from about 5 to about 20 phr of resin comprised of at least one of hydrocarbon resins, phenol/acetylene resins and rosin acid resins.

According to still another aspect of the water based adhesive, the adhesive may contain from about 2 to about 70 phr of rubber reinforcing carbon black.

According to yet another aspect of the water based adhesive, the adhesive may contain at least one of zinc oxide and fatty acid comprised of at least one of stearic, palmitic and oleic acid.

A pneumatic tire for use with the present invention may include an assembly of uncured rubber components including an outer circumferential uncured tread rubber strip with opposing ends of the tread rubber strip joined to form a splice which includes the dried cement composition between the opposing ends of the rubber strip, the rubber composition of the uncured tread rubber strip is comprised of, based on parts by weight per 100 parts by weight of rubber (phr):

(A) 100 phr of at least one sulfur curable diene-based elastomer; and

(B) about 70 to about 200 phr of hydrophobated precipitated silica; the hydrophobated precipitated silica is comprised of precipitated silica hydrophobated with:
(1) at least one silica coupling agent comprised of:
   (a) bis (3-trialkoxysilylalkyl) polysulfide containing an average from about 2 to about 4 connecting sulfur atoms in its polysulfidic bridge (e.g. comprised of bis(3-triethoxysilylpropyl) polysulfide; or
   (b) alkoxyorganomercaptosilane;
(2) at least one alkoxysilane; and
(3) combination of the silica coupling agent and alkoxysilane.

According to another aspect of the pneumatic tire, the rubber composition of the tread rubber strip contains from about 105 to about 175 phr of the hydrophobated precipitated silica.

According to still another aspect of the pneumatic tire, the rubber composition of the tread rubber strip where the diene based elastomer is comprised of at least one polymer of at least one of isoprene and 1,3-butadiene and styrene with at least one of isoprene and 1,3-butadiene.

According to yet another aspect of the pneumatic tire, at least one of the elastomers is a functionalized elastomer containing at least one functional group comprised of at least one of amine, siloxy, carboxyl and hydroxyl groups reactive with hydroxyl groups on the hydrophobated precipitated silica.

According to still another aspect of the pneumatic tire, at least one of the elastomers is a tin or silicon coupled elastomer.

According to yet another aspect of the pneumatic tire, at least one of the elastomers is a tin or silicon coupled elastomer which is functionalized at least one functional group comprised of at least one of amine, siloxy, carboxyl and hydroxyl groups reactive with hydroxyl groups on the hydrophobated precipitated silica.

According to still another aspect of the pneumatic tire, the assembly of uncured rubber components is cured to form a pneumatic tire.

A second method for use with the present invention may include the steps of joining opposing ends of a circumferential uncured tread rubber strip, as a component of an assembly of uncured rubber components of a tire, comprises applying the water based adhesive to at least one surface of the opposing ends of the uncured tire tread rubber strip and drying the cement to promote building tack for tread strip ends and the uncured tread rubber strip ends then joined with the dried cement there between to form a splice, following which the assembly of uncured rubber components is cured to form a tire; the rubber composition of the uncured rubber tread strip is comprised of, based on parts by weight per 100 parts by weight of rubber (phr):

(A) 100 phr of at least one sulfur curable diene-based elastomer; and

(B) about 70 to about 200 phr of hydrophobated precipitated silica; the hydrophobated precipitated silica is comprised of precipitated silica hydrophobated with:
(1) at least one silica coupling agent comprised of:
   (a) bis (3-trialkoxysilylalkyl) polysulfide containing an average from about 2 to about 4 connecting sulfur atoms in its polysulfidic bridge (e.g. comprised of bis(3-triethoxysilylpropyl) polysulfide; or
   (b) alkoxyorganomercaptosilane;
(2) at least one alkoxysilane; and
(3) combination of the silica coupling agent and alkoxysilane.

According to another aspect of the second method, the rubber composition of the tread rubber strip contains from about 105 to about 175 phr of the hydrophobated precipitated silica.

According to still another aspect of the second method, the rubber composition of the tread rubber strip where the diene based elastomer is comprised of at least one polymer of at least one of isoprene and 1,3-butadiene and styrene with at least one of isoprene and 1,3-butadiene.

According to yet another aspect of the second method, at least one of the elastomers is a functionalized elastomer containing at least one functional group comprised of at least one of amine, siloxy, carboxyl and hydroxyl groups reactive with hydroxyl groups on the hydrophobated precipitated silica.

According to another aspect of the second method, at least one of the elastomers is a tin or silicon coupled elastomer.

According to yet another aspect of the second method, at least one of the elastomers is a tin or silicon coupled elastomer which is functionalized at least one functional group comprised of at least one of amine, siloxy, carboxyl and hydroxyl groups reactive with hydroxyl groups on the hydrophobated precipitated silica.

According to still another aspect of the second method, a further step may include heating the cement coating on an end of the uncured rubber strip, prior to joining the strip ends to form the splice, to enhance or reduce the drying time of the water based cement and also to soften the rubber composition at the end of the uncured rubber strip to enhance an associated building tack.

### BRIEF DESCRIPTION OF THE DRAWINGS

FIG. 1 shows a schematic representation of a system and method in accordance with the present invention.

### DETAILED DESCRIPTION OF EXAMPLES OF THE PRESENT INVENTION

In accordance with the present invention, a system and/or method 1 for adhering uncured/cured tread strip ends to each other may include a heating means and a water based adhesive both applied at a tread splice or joint. Such a system/method 1 may provide an excellent, quick drying pressure sensitive tack in the uncured or cured stage, as well as excellent adhesion in the postcured stage. An example water based adhesive is described in concurrently filed U.S. patent application Ser. No. 13/744,549, titled “Water Based Rubber Cement and Tire with Fabricated Tread”, also to the herein named inventor, Paul Harry Sandstrom, incorporated herein by reference.

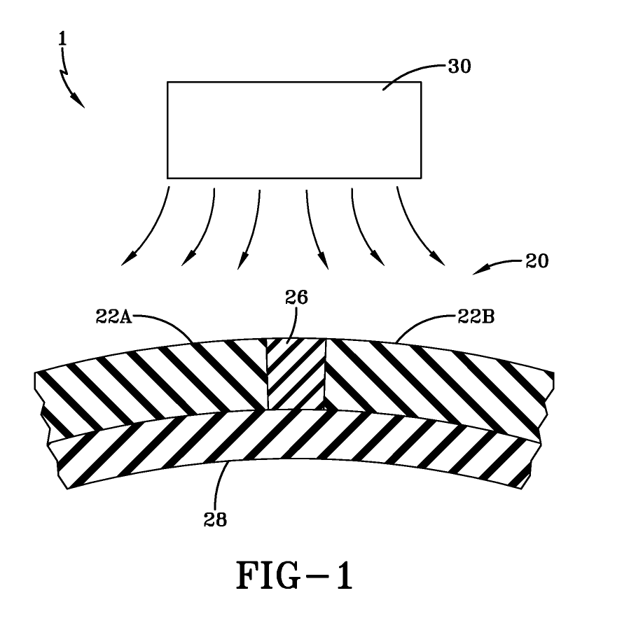

Thus, as shown in FIG. 1, a spliced tire tread joint or tread splice portion (e.g., uncured or cured) in accordance with the present invention may be generally indicated by the numeral 20 and may include two tread ends 22a, 22b adhered to each other by a splice material 26, which may be a water based elastomeric adhesive composition. The tread splice portion 20 may reside upon a tire ply or carcass substrate 28. Although not shown, the carcass substrate 28 may also be bonded, adhered, or joined to the tire tread 22a, 22b through the use of a conventional adhesive or through the use of the above described splice material 26.

Conventionally, solvent based cements have been used to provide good integrity of tread splices in the green state and the post cure state. An environmental desire to remove solvents from all processes has a system and method, in accordance with the present invention applying one or more tread end heaters 30 and a water based cement 26 as a more environmentally desirable replacement for solvent based cements, while maintaining equivalent or better tread splice integrities and tread splice drying durations.

Longer drying durations when using water based cements rather than solvent based cements has been encountered previously and has prevented their use in tire production. Further, splice integrity when using tread end heaters without cement has not been acceptable in tire production. The system/method 1 of the present invention may use the water based cement 26 combined with a tread end heater 30. The heater or heaters 30 may be infrared, convection, radiant, induction, and/or other suitable heating means and may provide temperatures at the tread end and adhesive surfaces of 80° C. to 120° C. Thus, the drying duration may be reduced. Also, an adhesive deposit on the surface of the tread ends 22A, 22B may be provided after drying for enhancing overall bonding of the tread splices 20. The heater(s) 30 may be applied to the tread ends 22A, 22B before, during, and/or after the water based cement 26 is applied to the tread ends.

The system/method 1 may also enable the use water based cements previously ruled out because of lengthy drying durations. Such previously unused water based cements may further enhance the integrity of the deposit left behind, such as improved tack and bonding at the tread splice interface 20. Additional tread compounds may thus be used for improving functional properties of the tire, such as wet traction and rolling resistance.

The method of making the pneumatic tire 1 may include the steps of applying the cement composition 26 to a tread component 22A, 22B, incorporating the tread component 22A, 22B into the pneumatic tire 1, and heating the ends 22A, 22B of the tread component in order to cure the cement composition 26 and secure the tread ends 22A, 22B to each other and the pneumatic tire 1.

Elastomers for one example composition 26 may be natural rubber, styrene butadiene rubber, polybutadiene rubber and mixtures thereof, may be employed in the composition of the present invention. For example, about 35 percent to 50 percent of elastomer by total weight of the composition 26 may be used for optimal adhesive properties. The composition 26 may further comprise from about 0.02 to 0.6 weight percent pH adjusters selected from the group consisting of potassium hydroxide, aqueous ammonia, and mixtures thereof.

The example composition 26 may also comprise about 0.1 percent to 1.8 percent surfactant/stabilizer selected from the group consisting of sodium lignosulfate, octylphenoxypolyethoxyethanol, polyoxyethylene sorbitrol fatty acid ester, sulfated fatty acid, and mixtures thereof. In addition to the above ingredients, the composition 26 may comprise about 0.5 percent to 5 percent carbon black selected from the group consisting of N-300 and N-200 series (designations used in the adhesive industry for carbon blacks) and mixtures thereof.

The example composition 26 may also comprise about 0.02 percent to 0.75 percent zinc oxide, about 0.01 percent to 0.4 percent sulfur, and about 0.005 percent to 0.2 percent accelerator selected from the group consisting of dibenzothiazyl disulfide, tetraethyl thiuram disulfide, tetramethyl thiuram disulfide, tetramethyl thiuram monosulfide, n-tert-butyl-2-benzothiazolesulfenamide, diphenyl guanidine and mixtures thereof. The example composition 26 may be manufactured by making a water dispersion of the carbon black, zinc oxide, sulfur, and the accelerator(s). This dispersion may be mixed with the elastomer emulsion and additional water, using mild agitation. The total water content may be about 40 to 60 weight percent (by total weight of the composition 26).

The aqueous adhesive 26 resulting therefrom may be applied to the splice ends 22A, 22B of an uncured or cured tire tread and also a carcass portion 28 by spraying, dipping, brushing, and/or flooding. After drying facilitated by the heater(s) 30, the adhesive 26 may form a thin layer between the splice ends 22A, 22B. Further operations in the building/manufacture of the pneumatic tire 1 may be carried out in a suitable manner.

Alternatively, the example composition 26 may include up to about 0.50 weight percent viscosity adjusters selected from the group consisting of hydroxyethyl cellulose, hydroxypropyl methylcellulose, and mixtures thereof. Up to about 15.00 weight percent resin emulsion selected from the group consisting of alkylphenol novolac, hydrogenated rosin, and mixtures thereof, is also an optional ingredient of the composition 26.

Thus, it is apparent that there has been provided, in accordance with the present invention, a system/method useful with natural and synthetic rubbers, which fully satisfies the aspects and advantages set forth above. While the present invention has been described in conjunction with specific examples thereof, it is evident that many alternatives, modifications, and variations will be apparent to those skilled in the art in light of the foregoing description. Accordingly, it is intended to embrace all such alternatives, modifications, and/or variations which fall within the spirit and scope of the appended claims.

1. A system for constructing a pneumatic tire comprising:
a tread component having two opposite tread splice ends;
a water based adhesive applied to the tread splice ends for securing the tread splice ends to each other, the water based adhesive including about 0.02 to 0.6 weight percent pH adjusters selected from the group of potassium hydroxide, aqueous ammonia, and mixtures thereof, the water based adhesive further including elastomers from the group consisting of natural rubber, styrene butadiene rubber, polybutadiene rubber, and mixtures thereof, the water based adhesive comprising 35 percent to 50 percent total weight of elastomer; and
a heater applying heat to the tread splice ends and water based adhesive for reducing drying duration of the water based adhesive, the heat being applied to the cured tread splice ends prior to application of the water based adhesive.

2. (canceled)

3. (canceled)

4. The system as set forth in claim 1 wherein the tread component is uncured.

5. The system as set forth in claim 1 wherein the water based adhesive also secures the tread component to a tire carcass structure.

6. The system as set forth in claim 1 wherein the heater comprises one or more of the group consisting of infrared heaters, convection heaters, radiant heaters, and induction heaters.

7. The system as set forth in claim 1 wherein the pneumatic tire is a retreaded pneumatic tire.

8. (canceled)

9. (canceled)

10. (canceled)

11. A method for constructing a pneumatic tire comprising the steps of:
providing a tread component having two opposite tread splice ends;
securing the tread splice ends to each other with a water based adhesive applied to the tread splice ends; and
applying heat to the tread splice ends and water based adhesive for reducing drying duration of the water based adhesive.

12. The method as set forth in claim 11 wherein the applying step is applied to the tread splice ends prior to the securing step.

13. The method as set forth in claim 12 wherein the tread component is cured.

14. The method as set forth in claim 12 wherein the tread component is uncured.

15. The method as set forth in claim 12 wherein the securing step further includes securing the tread component to a tire carcass structure with the water based adhesive.

16. The method as set forth in claim 15 wherein the applying step includes utilizing a heating means of the group consisting of infrared heaters, convection heaters, radiant heaters, and induction heaters.

17. The method as set forth in claim 16 wherein the pneumatic tire is a retreaded pneumatic tire.

18. The method as set forth in claim 17 wherein the water based adhesive includes elastomers from the group consisting of natural rubber, styrene butadiene rubber, polybutadiene rubber, and mixtures thereof.

19. The method as set forth in claim 18 wherein the water based adhesive comprises 35 percent to 50 percent total weight of elastomer.

20. The method as set forth in claim 19 wherein the water based adhesive includes about 0.02 to 0.6 weight percent pH adjusters selected from the group of potassium hydroxide, aqueous ammonia, and mixtures thereof.
